(19) United States
(12) Patent Application Publication
(10) Pub. No.: US 2008/0057761 A1
(43) Pub. Date: Mar. 6, 2008

(54) A Connector

(76) Inventor: James Stephen Mason, HAMPSHIRE (GB)

Correspondence Address: INTERNATIONAL BUSINESS MACHINES CORPORATION, 9000 SOUTH RITA ROAD, TUCSON, AZ, 85744, US

(21) Appl. No.: 11/571,185

(22) PCT Filed: Jun. 7, 2005
(86) PCT No.: PCT/EP05/52601

§ 371 Date: Feb. 22, 2007

(30) Foreign Application Priority Data
Jun. 23, 2004 (GB) 0414007.5

(51) Int. Cl. H01R 29/00

(52) U.S. Cl. 439/170

(57) ABSTRACT

A connector for use with a cable having components susceptible to triboelectrically-induced intercomponent charge comprises a signal component; a compensating resistive network to substantially equilibrate a plurality of triboelectrically-induced charges across the components; and a ground connect component for connecting the connector to ground prior to connection of the signal component. A process for manufacturing a connector for use with a cable having components susceptible to triboelectrically-induced intercomponent charge and comprises steps of: providing a signal component; providing a compensating resistive network to substantially equilibrate a plurality of triboelectrically-induced charges across the components; and providing a ground connect component for connecting the connector to ground prior to connection of the signal component.

### TECHNICAL FIELD

The present invention relates to cable and connector assemblies, and more particularly to cable and connector assemblies used for high-frequency transmission lines.

### BACKGROUND ART

The triboelectric effect is an electrical phenomenon in which certain materials can become electrically charged by friction or being rubbed against another material. In the context of electrical cables, it is well known that cables can become charged as they are handled and that this can cause significant charge differentials to be induced across the interconductor capacitances. Due to the low leakage of modern cables, charge can remain on the conductors until the cable is plugged into the associated equipment, whereupon the high voltage can cause serious damage to the interface electronics unless sufficient transient protection is provided. This effect is also occasionally termed ‘cable static’ and presents a general problem by providing a source of static electrical charge which can cause significant damage to electronic equipment. The use of integrated electronics and high speeds of operation in modern communications systems makes this problem more serious as the smaller feature size of the active devices connected to the line make them more susceptible to transient damage and the high frequency of operation make the inclusion of protection networks more difficult.

A typical modern datacommunications cable comprises 4 wires which make up two differential pairs formed by the white-blue and red-green wires. Another well-known data-carrying cable is the flat ribbon cable typically used, for example, to connect motherboards to hard disk drives. Each of the wires in such cables has a mutual capacitance to each other wire and also down to the cable shield. As the cable is moved across another material, all of these capacitances can become triboelectrically charged with intercomponent charge differentials. Due to the very low leakage associated with these capacitances the discharge time can be long enough such that significant intercomponent charge differentials remain when the signal-bearing components of the cable are plugged into equipment.

It would thus be desirable to alleviate the aforementioned disadvantageous potential for large differential charges being discharged into sensitive devices.

### DISCLOSURE OF INVENTION

In a first aspect, the present invention provides a connector for use with a cable having components susceptible to triboelectrically-induced intercomponent charge and comprising: a signal component; a compensating resistive network to substantially equilibrate a plurality of triboelectrically-induced charges across said components; and a ground connect component for connecting said connector to ground prior to connection of the signal component.

Preferably, said compensating resistive network comprises a discrete component in said connector.

Preferably, said discrete component is mounted on a PCB.

Preferably, said compensating resistive network comprises an integrated component in said connector.

Preferably, said integrated component is mounted on a PCB.

Preferably, said compensating resistive network comprises a conductive material used as a header in said connector.

Preferably, the ground connect component is of greater length than the signal component.

There is preferably provided a cable assembly comprising a cable and attached thereto a connector according to the first aspect of the present invention.

In a second aspect, the present invention provides a process for manufacturing a connector for use with a cable having components susceptible to triboelectrically-induced intercomponent charge and comprising steps of: providing a signal component; providing a compensating resistive network to substantially equilibrate a plurality of triboelectrically-induced charges across said components; and providing a ground connect component for connecting said connector to ground prior to connection of the signal component.

Preferably, said compensating resistive network comprises a discrete component in one or more of said connectors.

Preferably, said discrete component is mounted on a PCB.

Preferably, said compensating resistive network comprises an integrated component in one or more of said connectors.

Preferably, said integrated component is mounted on a PCB.

Preferably, said compensating resistive network comprises a conductive material used as a header in one or more of said connectors.

Preferably, the ground connect component is made to be of greater length than the signal component.

There is preferably provided a process for manufacturing a cable assembly comprising steps of: providing a cable; and providing a connector produced by a process according to the second aspect of the present invention.

### BRIEF DESCRIPTION OF THE DRAWINGS

A preferred embodiment of the present invention will now be described, by way of example only, with reference to the accompanying drawing figures, in which:

FIG. 1 illustrates the interconductor capacitances for a single differential pair in a cable.

FIG. 2 illustrates the insertion of discharge resistors at the cable connectors according to one possible embodiment of the present invention.

FIG. 3 shows in schematic form a cable connected to a connector according to a preferred embodiment of the present invention.

### BEST MODE FOR CARRYING OUT THE INVENTION

Preferred embodiments of the present invention address the problem of triboelectrically-induced intercomponent capacitance discharge for the transmission line case where the characteristic impedance of the line is typically only several hundred ohms at most. In this case, it is possible to introduce a parallel discharge path to the interconductor capacitances which is much higher than the characteristic impedance. This discharge network can thus have a negligible effect on the line performance.

In preferred embodiments of the present invention, there is provided a discharge path within the cable assembly itself such that any induced charge differentials can be equilibrated before the signal components of the cable are connected to equipment. The charge can then be conducted to ground, as is well known, by means of a ground connector that connects prior to the connection of any signal pins. It is well known that increasing the loss of the cable would be detrimental to its overall performance. However, a parallel resistance which connects across each cable capacitance at each connector could be arranged to have a much lower effect on the performance of the cable/connector system. Moreover this resistance could be conveniently implemented at low cost by introducing a resistive component to the material which conventionally provides the insulating support between the pins of the connector.

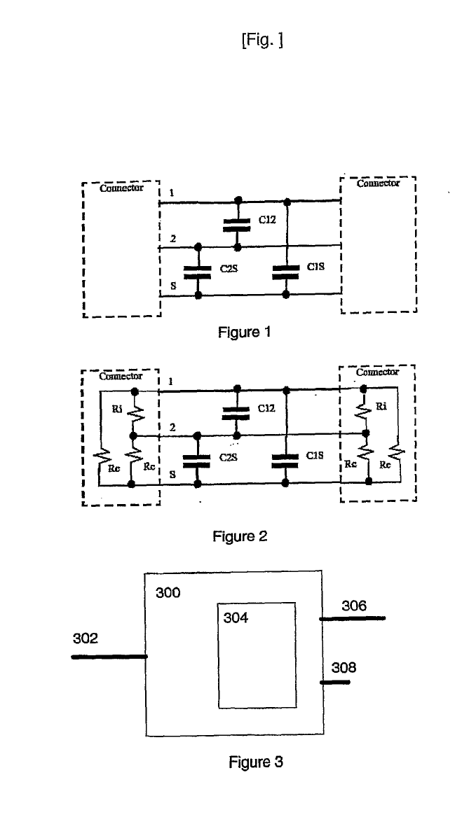

The electrical representation of the interconductor capacitances of one pair within such a cable is shown in FIG. 1. The capacitance between the wires (marked 1 and 2) in the differential pair is represented by C12 and that between each wire and the shield (denoted by S) by C1S and C2S. If the cable is operating as a transmission line then the termination impedances will be close to the characteristic impedance of the cable which is typically in the 30 to 300 ohm range. Consequently it is possible to place resistances in parallel with the cable capacitances of FIG. 2 such that they have a negligible effect on the termination impedance but provide a discharge path for any triboelectrically induced charge differentials; this is shown in FIG. 2. As an example, if this discharge resistance is 1000× the termination impedance it would typically have a value of several hundred kilohms.

Turning to FIG. 3, there is shown in schematic form a cable 302, together with connector 300, forming one end of a cable and connector assembly according to a preferred embodiment of the invention. In connector 300 is compensating resistive network 304. Compensating resistive network 304 substantially equilibrates triboelectrically-induced charges across the components. Also shown are a ground connect component 306 and a signal component 308. The ground connect component 306 is selected to connect the connector 300 to ground prior to the connection of signal component 308. Clearly, this may be done simply by, for example, making ground connect component 306 longer than signal component 308.

The discharge resistance network could be built using discrete components within the connector. However a lower cost and more convenient method would be to make the part of the connector which houses the individual pins conductive. In a conventional DB9 connector, for example, which represents a typical connector used in this application, a plastic moulding, known here as a header, is used to mechanically support and isolate the signal pins. It is possible to increase the conductivity of such a plastic material, for example by loading the moulding material with conductive particles. In this way the header could be made sufficiently resistive such that suitable discharge resistance paths existed between the signal pins and shield connections. The geometric design of the header would place constraints on the ratios of the various discharge resistance paths but as has been previously seen, this application would accept a large tolerance on these resistor values.

Another typical connector, well known to the person of ordinary skill in the art, is the HSSDC connector, where a single row of contacts is mounted on a pin support and insulator. As before, this pin support could be made resistive by making the moulding from a material with the appropriate level of conductivity. Alternatively some connectors are able to house an internal printed circuit board (PCB). An appropriate discharge network could be mounted on this PCB from either discrete or integrated components. Such a solution is likely to be more costly but more accurate then the use of conductive materials in the connector header.

Described here are preferred embodiments of the present invention, and it will be clear to one of ordinary skill in the art that there may be many modifications still falling within the scope of the present invention.

1. A connector for use with a cable having components susceptible to triboelectrically-induced intercomponent charge and comprising: a signal component; a compensating resistive network to substantially equilibrate a plurality of triboelectrically-induced charges across said components; and a ground connect component for connecting said connector to ground prior to connection of the signal component.

2. The connector as claimed in claim, wherein said compensating resistive network comprises a discrete component in said connector.

3. The connector as claimed in claim 2, wherein said discrete component is mounted on a PCB.

4. The connector as claimed in claim 1, wherein said compensating resistive network comprises an integrated component in said connector.

5. The connector as claimed in claim 4, wherein said integrated component is mounted on a PCB.

6. The connector as claimed in claim 1, wherein said compensating resistive network comprises a conductive material used as a header in said connector.

7. The connector as claimed in any preceding claim, wherein the ground connect component is of greater length than the signal component.

8. A cable assembly comprising a cable and attached thereto a connector as claimed in any preceding claim.

9. A process for manufacturing a connector for use with a cable having components susceptible to triboelectrically-induced intercomponent charge and comprising steps of: providing a signal component; providing a compensating resistive network to substantially equilibrate a plurality of triboelectrically-induced charges across said components; and providing a ground connect component for connecting said connector to ground prior to connection of the signal component.

10. The process as claimed in claim 9, wherein said compensating resistive network comprises a discrete component in one or more of said connectors.

11. The process as claimed in claim 10, wherein said discrete component is mounted on a PCB.

12. The process as claimed in claim 9, wherein said compensating resistive network comprises an integrated component in one or more of said connectors.

13. The process as claimed in claim 12, wherein said integrated component is mounted on a PCB.

14. The process as claimed in 9, wherein said compensating resistive network comprises a conductive material used as a header in one or more of said connectors.

15. The process as claimed in any of claims 9 to 14, wherein the ground connect component is made to be of greater length than the signal component.

16. A process for manufacturing a cable assembly comprising steps of: providing a cable; and providing a connector produced by a process according to any of claims 9 to 15.
